(19) United States
(12) Patent Application Publication
(10) Pub. No.: US 2020/0177566 A1
(43) Pub. Date: Jun. 4, 2020

(54) METHOD AND SYSTEM FOR COOPERATIVE INSPECTION OF ENCRYPTED SESSIONS

(71) Applicant: CHECKPOINT SOFTWARE TECHNOLOGIES LTD., Tel Aviv (IL)

(72) Inventors: Nir NAAMAN, Modiin (IL); Guy OFFER, Beit Alfa (IL); Tamir ZEGMAN, Tel Aviv (IL)

(21) Appl. No.: 16/203,655

(22) Filed: Nov. 29, 2018

(51) Int. Cl. H04L 29/06; H04L 9/14

(52) U.S. Cl. CPC H04L 63/061; H04L 63/166; H04L 9/14

(57) ABSTRACT

The present invention is a computer system, such cooperator is coupled to a negotiator, which is associated with one of the peers, a client (client computer) or server (e.g., a computer), to a Transport Layer Security (TLS)/Secure Socket Layer (SSL) session and its associated handshake between the peers. The cooperator is configured such that it can obtain parts of the handshake between peers, without taking part in the handshake.

### TECHNICAL FIELD

The present invention relates to cryptographic protocols designed to provide communications security over computer networks, and particularly to Secure Sockets Layer (SSL)/Transport Layer Security (TLS) inspection.

### BACKGROUND

Security devices as well as networking devices, including load balancers, are deployed to inspect encrypted traffic using protocols such as SSL or TLS. SSL and TLS are defined in a series of Request For Comments (RFCs), the latest is RFC 8446 (https://tools.ietf.org/html/rfc8446), this document is incorporated by reference herein. The networking devices are designed for blocking traffic, shaping traffic, steering traffic, or otherwise analyzing traffic so as to prioritize and control its flow, or to generate analytical conclusions for other purposes (e.g. targeted advertising).

For example, as shown in FIG. 1, a security device 10 sits along communication network(s), such as the Internet, between a client 12 and a server 14, to inspect encrypted traffic between the client 12 and server 14. The security device 10 is such that two separate TLS sessions occur, one between the security device 10 and the client 12, and the other between the security device 10 and the server 14. The security device 10 operates as a “man-in-the-middle” and inspects and/or modifies post handshake data, which passes through between the client 12 and server 14, and vice versa.

One application of the security device 10, as shown in FIG. 1, is such that the security device 10, also known as a “security gateway”, is provided with the long term cryptographic keys of the client 12 and/or server 14, to support TLS or SSL sessions, for example, RSA key pairs. These RSA key pairs are involved in negotiating the session keys used to secure the traffic that needs to be inspected by the security device 10.

However, this approach has many drawbacks. These drawbacks include security concerns resulting from sharing of the long term private keys, as it affects the security of all traffic negotiated using these keys and might not even be allowed according to the security policy of the enterprise associated with the security device or other regulations. Also, the computational cost of using the long term keys on the security gateway is high. Additionally, the use of the long term keys to inspect encrypted traffic is, in most cases, only possible when deploying the security device as an active “man-in-the-middle,” thus preventing any inspection of the traffic when the security device 10 is not placed in between the client 12 and the server 14.

Another approach, also shown in FIG. 1, is to configure at least one party, the client 12 or the server 14, of the encrypted session, to trust a certificate issued to the security device 10, allowing it to represent the identity of the peer, using the security device's 10 own long term keys. In this configuration, the security device 10 acts as a “man-in-the-middle,” as shown in FIG. 1, and the security device 10 maintains two independent encrypted sessions, one with the client 12 and another with the server 14. This approach also has drawbacks, which include a high computational cost of using long term keys on the security gateway 10. Also, the security device 10 must be deployed as an active “man-in-the-middle,” thereby preventing deployments in which the security device 10 is not placed in between the client 12 and the server 14. Additionally, this approach fails altogether, as either or both the client 12 and the server 14 will not allow the security device to act as a “man-in-the-middle” (MITM).

### SUMMARY

The present invention is a computer system, such cooperator is coupled to a negotiator, which is associated with one of the peers, a client (client computer) or server (e.g., a computer), to a Transport Layer Security (TLS)/Secure Socket Layer (SSL) session and its associated handshake between the peers. The cooperator is configured such that it can obtain parts of the handshake between peers, without taking part in the handshake. The cooperator obtains parts of the handshake, such as cryptographic keys and secrets from the negotiator, and passes these parts to a security gateway or other device that can decrypt and analyze the session.

Embodiments of the invention are directed to a method for inspecting encrypted sessions between computers. The method comprises: associating a cooperator with a negotiator, the negotiator associated with a first computer to an encrypted session between the first computer and at least one second computer, the encrypted session including cryptographic keys and session information; the cooperator obtaining the cryptographic keys and the session information from the negotiator, and passing the cryptographic keys and the session information to an inspection device for inspecting the encrypted session.

Optionally, the method is such that the encrypted session is negotiated by using a protocol.

Optionally, the method is such that the protocol includes at least one of a Transport Layer Security (TLS) protocol or a Secure Socket Layer (SSL) protocol.

Optionally, the method is such that the cryptographic keys comprise one or more of an SSL master secret or a TLS master secret.

Optionally, the method is such that the cryptographic keys comprise at least one of SSL session keys or TLS session keys.

Optionally, the method is such that the session information includes at least one of: an SSL identifier or a TLS session identifier; a TLS ticket; the identity of one or more of the first computer and/or the second computer; additional data associated with an SSL handshake or a TLS handshake associated with the encrypted session from at least one of the first computer and/or the second computer; an Internet Protocol (IP) address of one or more of the first computer and/or the second computer; and, layer 4 ports of the session.

Optionally, the method is such that the first computer includes a server, and at least one the second computer includes a client.

Optionally, the method is such that the first computer includes a client, and the at least one second computer includes a server.

Optionally, the method is such that the first computer includes a server.

Optionally, the method is such that the first computer includes a client.

Optionally, the method is such that the cooperator obtains the cryptographic keys and the session information from the negotiator by pulling the cryptographic keys and the session information from the negotiator.

Embodiments of the invention are directed to a computer system for obtaining data associated with encrypted sessions between computers. The system comprises: a cooperator, which is configured for: 1) coupling with a negotiator associated with a first computer participating in an encrypted session with at least one second computer, the encrypted session including cryptographic keys and session information; and, 2) obtaining the cryptographic keys and the session information from the negotiator, and passing the cryptographic keys and the session information to an inspection device for inspecting the encrypted session.

Optionally, the system is such that the cooperator obtains the cryptographic keys and the session information from the negotiator having negotiated the encrypted session using a protocol.

Optionally, the system is such that the protocol includes at least one of Transport Layer Security (TLS) protocol or Secure Socket Layer (SSL) protocol.

Optionally, the system is such that the cryptographic keys comprise one or more of an SSL master secret or a TLS master secret.

Optionally, the system is such that the cryptographic keys comprise at least one of SSL session keys or TLS session keys.

Optionally, the system is such that the session information includes at least one of: an SSL identifier or a TLS session identifier; a TLS ticket; the identity of one or more of the first computer and/or the second computer; additional data associated with an SSL handshake or a TLS handshake associated with the encrypted session from at least one of the first computer and/or the second computer; an IP address of one or more of the first computer and/or the second computer; and, layer 4 ports of the session.

Optionally, the system is such that first computer includes at least one of a server or a client.

Optionally, the system is such that the at least one second computer includes a client.

Optionally, the system is such that the at least one second computer includes a server.

This document references terms that are used consistently or interchangeably herein. These terms, including variations thereof, are as follows.

A “computer” includes machines, computing or computer systems (for example, physically separate locations or devices), servers, computer devices, computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location, e.g., a smartphone, personal digital assistant (PDA), mobile telephone or cellular telephone, a watch digitally linked to a network such as the Internet, or other wearable technology such as a digital watch, bracelet or wristband.

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine or a software based emulation of a computer.

A “client” is an application that runs on a computer, workstation or the like and relies on a server to perform some of its operations or functionality. A client is, for example, represented as a computer in this document.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating the Prior Art “man-in-the-middle” security device between a client and a server;

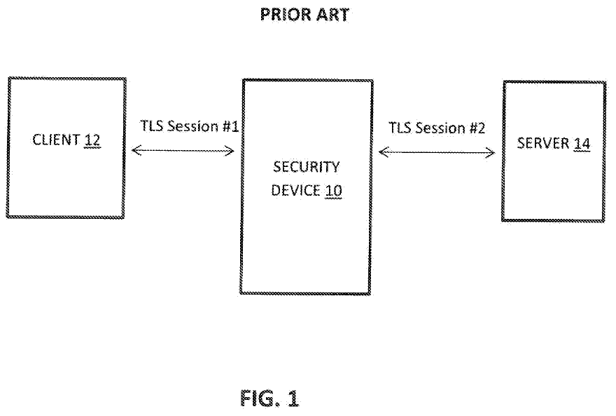

FIG. 2A is a diagram illustrating the present invention in operation with a security device;

FIG. 2B is a flow diagram of a method performed by the present invention of FIG. 2A;

FIG. 3A is a diagram illustrating another embodiment of the present invention in operation with a security device; and,

FIG. 3B shows a flow diagram of a method performed by the present invention of FIG. 3A.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

The present invention overcomes the drawbacks of the prior art by providing a system which allows a security device to inspect traffic through cooperation with at least one party of, and typically one party of, the connection. The cooperating side is modified with the system of the invention, so that the system associated with the cooperating side shares negotiated keys with the security device.

The security device receives the negotiated keys along with any additional information needed in order to correlate the keys with the sessions, that these negotiated keys are used for. The security device uses the information it has received from the system to decrypt and inspect the encrypted sessions.

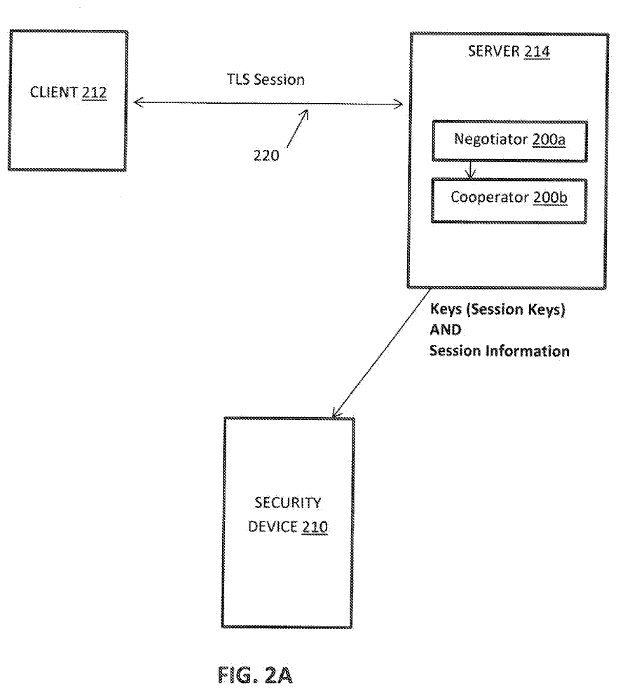

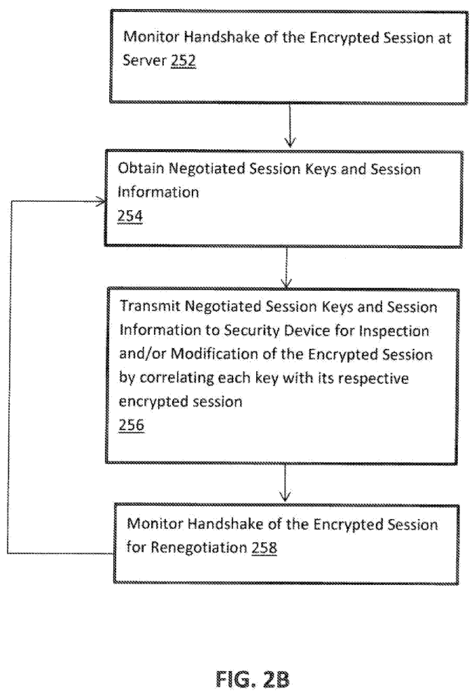

FIG. 2A shows the present invention as a negotiator 200a, coupled with a cooperator 200b, in operation on a server 214. The negotiator 200a is, for example, a TLS/SSL library employed by the server 214. The negotiator 200a is configured to be coupled with the cooperator 200b. The cooperator 200b functions to obtain the session keys from the negotiator 200a, and provide them to the security device 210.

The server 214 communicates with a client 212 in an encrypted session, for example, a Transport Layer Security (TLS) session (indicated by the double-headed arrow 220). The server 214 and client 212 conduct the session 220, for example, over a communications network, such as the Internet. The cooperator 200b, as associated with the server 214, communicates with the security device 210, for example, also over a communications network, such as the Internet. The aforementioned communications include electronic and/or data communications, both wired, wireless or combinations thereof, over networks, such as the Internet. The client 212 and server 214 are parties to the TLS session 220 and its handshake, and therefore are peers with respect to each other.

The negotiator 200a (of the server 214) negotiates with a similar negotiator on the client 212. The negotiator 200a employs protocols to negotiate cryptographic sessions, including, for example, cryptographic keys for serving the data, which is transferred over the session. The protocols include, for example, TLS, SSL, IKE (Internet Key Exchange) and SSH (Secure Shell). For example, the negotiated cryptographic keys are symmetric keys, known to both the server 214 and the security device 210, as the use of symmetric keys is computationally inexpensive (when compared to the use of asymmetric keys).

The negotiation is such that, a protocol is used to negotiate a cryptographic session including cryptographic keys. The negotiated cryptographic session includes various attributes, such as, for example, 1) cryptographic algorithms, which are used for encryption, data integrity, data authenticity, 2) cryptographic keys, 3) additional attributes such as: compression algorithms and its parameters, and session length (measured in time and in data), and 4) the identities of one or more of the parties of the session. The cryptographic keys include specific key types, for example, SSL or TLS master secrets, which are short term keys, which can be used for multiple sessions, and these SSL and TLS master secrets are defined in the aforementioned RFC 8446.

The negotiator 200a also provides information as to the encrypted session, e.g., the TLS session, which includes, for example, the SSL or TLS session identifier (ID), a TLS ticket, the identity of one or more of the client 212 (client computer) and/or the server (e.g., computer), random (e.g., additional) data sent by the server in a SSL or TLS handshake, random data sent by the client in a SSL or TLS handshake, the Internet Protocol (IP) address of the server 214, the IP address of the client 212, and the Layer 4 ports of the session.

The cooperator 200b obtains, e.g., pulls, the negotiated session key(s) and session information from the negotiator 200b. The cooperator 200b then transmits the negotiated session key(s) and session information to the security device 210.

The security device 210 has received the negotiated keys along with the additional session information needed, in order to correlate the keys with the sessions, such that the negotiated keys can be used for decryption of the data for the encrypted session, e.g., the TLS session 220. The security device 210 uses the information it has received from the system 200 to decrypt and inspect the data of the encrypted sessions, e.g., TLS sessions 220. For example, the security device 210 receives an envelope with encrypted data, and inspects and/or, modifies the encrypted data. The inspection includes, for example, checking for the data for integrity, and decrypting it, as well as any renegotiations of keys. The modification includes inserting, deleting, overwriting, or reordering portions of the traffic, reshaping it, redirecting the traffic or blocking the traffic.

Attention is now directed to FIG. 2B, which shows a flow diagram detailing a computer-implemented process in accordance with embodiments of the disclosed subject matter. Reference is also made to elements shown in FIG. 2A. The process and subprocesses of FIG. 2B are computerized processes, and can be, for example, performed manually, automatically, or a combination thereof, and, for example, in real time.

Initially, at block 252, the handshake of the encrypted session 220 is monitored at the server 214, for example, by the negotiator 200a. The process moves to block 254, where the negotiator 200a obtains the negotiated session keys and session information. The negotiator 200a also provides information as to the encrypted session 220, e.g., the TLS session, which includes, for example, the SSL or TLS session ID, a TLS ticket, random data sent by the server in a SSL or TLS handshake, random data sent by the client in a SSL or TLS handshake, the Internet Protocol (IP) address of the server 214, the IP address of the client 212, and the Layer 4 ports of the session.

At block 256, the negotiated session keys and session information is transmitted, by the cooperator 200b, to the security device 210, for inspection and/or modification of the encrypted session, by correlating each key with its respective encrypted session. The security device 210 can receive the encrypted traffic, for inspection and/or modification in multiple ways including: 1) the security device 210 being placed as a man-in-the-middle, 2) the security device 210 receiving a copy in real-time from a networking device (e.g., a mirror port on switch); or, 3) by the security device 210 analyzing stored copies of the traffic (packet captures) retroactively, and matching it to session keys via meta data, such as time stamps and session peers.

The inspection includes, for example, checking for the data for integrity, and decrypting it, as well as any renegotiations of keys. The modification includes inserting, deleting, overwriting, or reordering portions of the traffic, reshaping it, redirecting the traffic or blocking the traffic.

The process moves to block 258, where the handshake for the encrypted session is again monitored for renegotiation, as performed by the negotiator 200a of the server 214 with the negotiator of the client 212, as detailed above. From block 258, the process returns to block 254, from where it resumes.

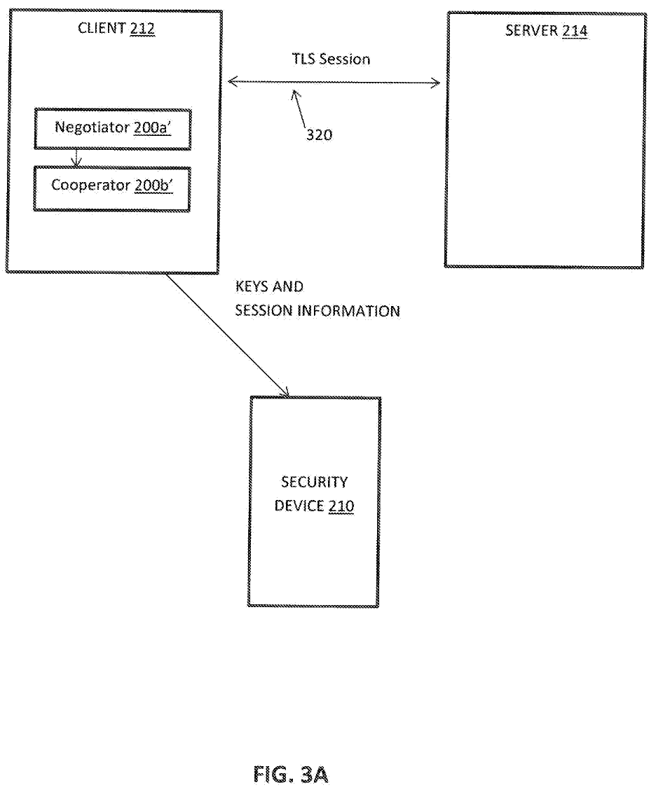

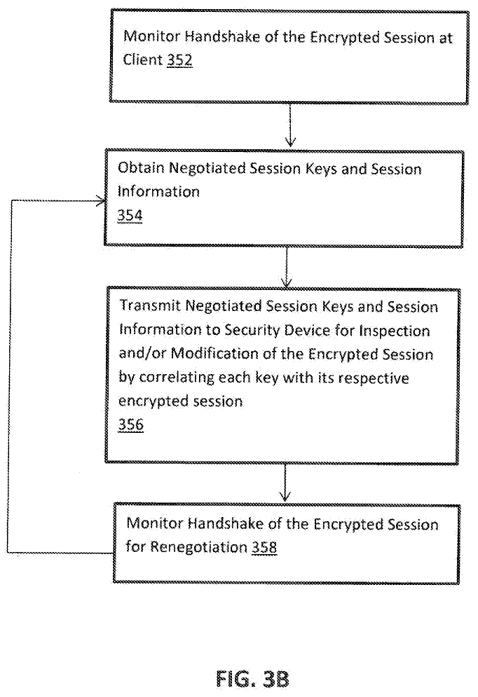

FIG. 3A shows the present invention as a negotiator 200a′, coupled with a cooperator 200b′, in operation on the client computer 212. Operation of the negotiator 200a′ and cooperator 200b′ is similar to that described for the respective negotiator 200a and cooperator 200b of the server 214 of FIG. 2A. The server 214 and client 212 conduct the session 320, for example, over a communications network, such as the Internet.

Attention is now directed to FIG. 3B, which shows a flow diagram detailing a computer-implemented process in accordance with embodiments of the disclosed subject matter. Reference is also made to elements shown in FIG. 3A. The process and subprocesses of FIG. 3B are computerized processes, and can be, for example, performed manually, automatically, or a combination thereof, and, for example, in real time.

Initially, at block 352, the handshake of the encrypted session 320 is monitored at the client 212, for example, by the negotiator 200a′. The negotiator 200a′ also provides information as to the encrypted session 320, e.g., the TLS session, which includes, for example, the SSL or TLS session ID, a TLS ticket, random data sent by the server in a SSL or TLS handshake, random data sent by the client in a SSL or TLS handshake, the Internet Protocol (IP) address of the server 214, the IP address of the client 212, and the Layer 4 ports of the session.

The process moves to block 354, where the negotiator 200a′ obtains the negotiated session keys and session information.

At block 356, the negotiated session keys and session information is transmitted, by the cooperator 200b′ of the client computer 212, to the security device 210, for inspection and/or modification of the encrypted session, by correlating each key with its respective encrypted session. The inspection includes, for example, checking for the data for integrity, and decrypting it, as well as any renegotiations of keys. The modification includes inserting, deleting, overwriting, or reordering portions of the traffic, reshaping it, redirecting the traffic or blocking the traffic. The process moves to block 358, where the handshake for the encrypted session is again monitored for renegotiation, as performed by the negotiator 200a′. From block 358, the process returns to block 354, from where it resumes.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for inspecting encrypted sessions between computers comprising:
associating a cooperator with a negotiator, the negotiator associated with a first computer to an encrypted session between the first computer and at least one second computer, the encrypted session including cryptographic keys and session information;
the cooperator obtaining the cryptographic keys and the session information from the negotiator, and passing the cryptographic keys and the session information to an inspection device for inspecting the encrypted session.

2. The method of claim 1, wherein the encrypted session is negotiated by using a protocol.

3. The method of claim 2, wherein the protocol includes at least one of a Transport Layer Security (TLS) protocol or a Secure Socket Layer (SSL) protocol.

4. The method of claim 3, wherein the cryptographic keys comprise one or more of an SSL master secret or a TLS master secret.

5. The method of claim 3, wherein the cryptographic keys comprise at least one of SSL session keys or TLS session keys.

6. The method of claim 1, wherein the session information includes at least one of:
an SSL identifier or a TLS session identifier;
a TLS ticket;
the identity of one or more of the first computer and/or the second computer;
additional data associated with an SSL handshake or a TLS handshake associated with the encrypted session from at least one of the first computer and/or the second computer;
an IP address of one or more of the first computer and/or the second computer; and,
layer 4 ports of the session.

7. The method of claim 1, wherein the first computer includes a server, and at least one the second computer includes a client.

8. The method of claim 1, wherein the first computer includes a client, and the at least one second computer includes a server.

9. The method of claim 1, wherein the first computer includes a server.

10. The method of claim 1, wherein the first computer includes a client.

11. The method of claim 1, wherein the cooperator obtains the cryptographic keys and the session information from the negotiator by pulling the cryptographic keys and the session information from the negotiator.

12. A computer system for obtaining data associated with encrypted sessions between computers comprising:
a cooperator configured for: 1) coupling with a negotiator associated with a first computer participating in an encrypted session with at least one second computer, the encrypted session including cryptographic keys and session information; and, 2) obtaining the cryptographic keys and the session information from the negotiator, and passing the cryptographic keys and the session information to an inspection device for inspecting the encrypted session.

13. The computer system of claim 12, wherein the cooperator obtains the cryptographic keys and the session information from the negotiator having negotiated the encrypted session using a protocol.

14. The computer system of claim 13, wherein the protocol includes at least one of Transport Layer Security (TLS) protocol or Secure Socket Layer (SSL) protocol.

15. The computer system of claim 14, wherein the cryptographic keys comprise one or more of an SSL master secret or a TLS master secret.

16. The computer system of claim 14, wherein the cryptographic keys comprise at least one of SSL session keys or TLS session keys.

17. The computer system of claim 12, wherein the session information includes at least one of:
an SSL identifier or a TLS session identifier;
a TLS ticket;
the identity of one or more of the first computer and/or the second computer;
additional data associated with an SSL handshake or a TLS handshake associated with the encrypted session from at least one of the first computer and/or the second computer;
an IP address of one or more of the first computer and/or the second computer; and,
layer 4 ports of the session.

18. The computer system of claim 12, wherein the first computer includes at least one of a server or a client.

19. The computer system of claim 18, wherein the at least one second computer includes a client.

20. The computer system of claim 18, wherein the at least one second computer includes a server.
